(19) United States
(12) Patent Application Publication
(10) Pub. No.: US 2023/0360084 A9
(43) Pub. Date: Nov. 9, 2023

(54) Creating an Advertisement Strategy

(71) Applicant: LottoAds Inc., Ball Ground, GA (US)

(72) Inventor: Neal Harley Landers, Mt. Pleasant, SC (US)

(21) Appl. No.: 15/829,976

(22) Filed: Dec. 3, 2017

Related U.S. Application Data
(63) Continuation-in-part of application No. 14/790,712, filed on Jul. 2, 2015, now Pat. No. 9,836,763.
Application No. 14/790,712 is a continuation-in-part of application No. 13/667,711, filed on Nov. 2, 2012, now Pat. No. 9,076,161.

(51) Int. Cl. G06Q 30/02

(52) U.S. Cl. CPC G06Q 30/0264; G06Q 30/0276; G06Q 30/0265; G06Q 30/0277

(57) ABSTRACT

Systems and methods for creating advertisement campaigns are provided. In one embodiments, an advertisement planning program comprises a creating module enabling a user to create an advertisement to be displayed within an advertisement area on each of one or more media components, such as a ticket that entitles a bearer of the respective ticket to enter a place, travel by public transport, participate in an event, or enter a lottery or raffle. The advertisement planning program also comprises a run time module configured to enable the user to enter time periods during which the advertisement is initially displayed. A location selection module is configured to enable the user to select one or more remote locations where the advertisement is to be initially displayed. The advertisement creating module enables the user to electronically insert and spatially arrange graphical and/or textual elements in a window representing a predetermined size and shape of the advertisement area.

### CROSS-REFERENCE TO RELATED APPLICATIONS

This application is a continuation-in-part of U.S. patent application Ser. No. 14/790,712, filed Jul. 2, 2015 and titled “Printing, Displaying, and Etching Advertisements on Various Media,” which is a continuation-in-part of U.S. patent application Ser. No. 13/667,711, filed Nov. 2, 2012 and titled “System for Printing an Advertisement on a Ticket,” which claims the benefit under 35 U.S.C. § 119 of U.S. Provisional Application No. 61/555,842, filed on Nov. 4, 2011, the entire disclosures of which are incorporated by reference herein.

### TECHNICAL FIELD

The present disclosure generally relates to advertising, and more particularly relates to systems and methods for enabling a user to create an advertisement strategy.

### BACKGROUND

For years, businesses have created advertisements to endorse their products, brands, etc. Normally, these advertisements can be presented to an audience in a number of ways. For example, some advertisements may be presented in printed form and published in newspapers, magazines, flyers, etc. Other advertisements may be presented in audible form, such as those communicated over the radio. Still others may include both visual and audible elements, such as those that are commonly presented on television or on a computer. Regarding printed advertisements, some businesses, such as restaurants, may choose to advertise by printing coupons. These coupons can be combined with other coupons from other businesses in coupon books, printed in newspapers and magazines, or printed on individual cards or flyers. Despite the numerous ways that a business may advertise, businesses are continually looking for new ways to distribute advertisements and coupons to their audience.

Also, businesses usually attempt to present their advertisements in a way that will reach the type of audience that they intend to target. For example, businesses may wish to purchase television advertisement slots to show commercials to an audience that may be more likely to buy their products or patronize their establishments. The advertisements can then more sharply focus on viewers who might have more of a tendency to watch the associated television programs. This can be done to expose the intended audience with their advertisements. It would be desirable for a business, however, to have greater flexibility in advertising to be able to target their audience so that advertisements can reach the people that may be more likely to use their products or visit their establishments.

### SUMMARY

The present disclosure describes various implementations of systems and methods for creating and planning an advertisement and advertisement strategy or campaign. According to one implementation, an advertisement planning device, as described in the present disclosure, includes an advertisement managing module configured to enable a user to electronically organize elements of an advertisement. The advertisement planning device also includes a run time module configured to enable the user to enter a time period when the advertisement is to be run and a location selection module configured to enable the user to select one or more predetermined locations where the advertisement is to be run.

The present disclosure also describes an embodiment of a system, which comprises an advertisement planning device configured to enable a user to create an advertisement strategy. The advertisement strategy includes electronically arranged elements of an advertisement, a time period when the advertisement is to be run, and one or more predetermined locations where the advertisement is to be run. The system also comprises a network and a user device associated with the user, the user device being configured to communicate with the advertisement planning device via the network to enable the user to create the advertisement strategy.

### BRIEF DESCRIPTION OF THE DRAWINGS

The features illustrated in the following figures are intended to emphasize the general principles of the present disclosure and are not necessarily drawn to scale. Consistent reference characters are used throughout the figures to designate corresponding features.

FIG. 1 is a block diagram showing a conventional ticket distribution system.

FIGS. 2A-2D are block diagrams showing advertisement systems according to various implementations of the present disclosure.

FIGS. 3A and 3B are block diagrams showing still more advertisement systems according to various implementations of the present disclosure.

FIG. 4 is a block diagram of an advertisement managing system according to various implementations of the present disclosure.

FIG. 5 is a block diagram of the advertisement planning device shown in FIG. 4, according to various implementations of the present disclosure.

FIG. 6 is a block diagram of the advertisement verification device shown in FIG. 4, according to various implementations of the present disclosure.

### DETAILED DESCRIPTION

The present disclosure describes systems and methods for creating an advertisement strategy, which may include not only the advertisement itself, but also time and location information for specifying when and where the advertisement is to be run. However, rather than using conventional means of presenting an advertisement to an audience, the advertisements according to various implementations of the present disclosure may be printed on any suitable type of ticket, such as a movie ticket, sporting event ticket, concert ticket, theater ticket, lottery ticket, rapid transit ticket, train ticket, airline ticket, or ticket for other events or purposes. In particular, the implementations disclosed herein may be combined with a lottery system, whereas an advertisement can be printed on a lottery ticket that is distributed to a person purchasing the lottery ticket. In particular, lottery tickets (and other types of tickets) represent a unique purchase in that they are printed for an individual at a known location and time. Unlike coupons that might normally get thrown away or ignored, the lottery ticket is usually held by the purchaser and read multiple times during the short lifespan of the ticket.

Using the implementations described in the present disclosure, an advertiser can create one or more advertisement strategies using a process involving online systems. The advertisements can then be distributed to ticket printing devices to be printed for individuals who wish to purchase some type of ticket. The regular ticket information is printed on the ticket along with the advertisement, and the ticket can be handed to the customer. With the example of lottery tickets, the advertisement can be printed on the same ticket that includes the lottery numbers. By allowing the advertisers to choose where the advertisements are printed, the advertisements can be distributed to people who might live or work in a specific area (e.g., near a particular restaurant). For example, lottery ticket printing devices, sometimes referred to as point-of-sale (POS) lottery machines, are usually housed in known, fixed locations, such as in convenience stores, gas stations, grocery stores, restaurants, bars, and other venues.

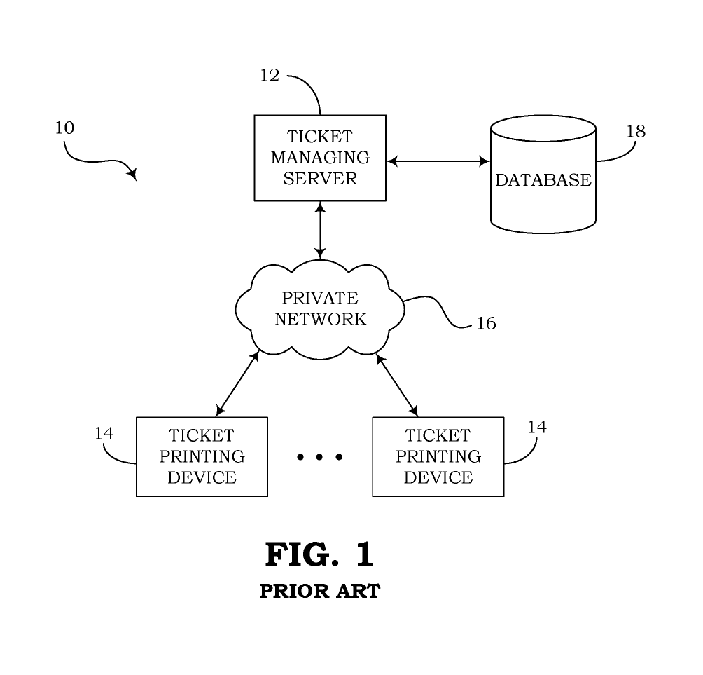

FIG. 1 is a block diagram illustrating a conventional ticket distribution system 10. As shown, the ticket distribution system 10 includes a ticket managing server 12 and a plurality of ticket printing devices 14, where the ticket managing server 12 communicates with the ticket printing devices 14 via a private network 16. The ticket managing server 12 may store ticket information in a database 18. In some embodiments, the ticket printing devices 14 do not communicate with each other, but only communicate with the ticket managing server 12. The ticket distribution system 10 may be a closed system that would normally not operate over the Internet. For security purposes, the private network 16 is normally inaccessible to devices outside the ticket distribution system 10.

In some embodiments, the ticket distribution system 10 is a lottery system that manages and controls the distribution and printing of lottery tickets. The ticket managing server 12 may include one or more computers for a state lottery system or may be the main computer(s) for a lottery system that extends into multiple states, such as the Mega Millions and Power Ball lottery systems. The ticket printing devices 14 may represent the point-of sale (POS) lottery machines where a customer can purchase a lottery ticket. In other embodiments, the ticket distribution system 10 may be related to a system for distributing and printing other types of tickets, such as movie tickets, concert tickets, airline tickets, etc.

When a customer wishes to purchase a lottery ticket (e.g., a ticket for Mega Millions, Power Ball, Daily Double, Pick 3, Pick 4, Win For Life, or other lottery game), the ticket printing device 14 prints out the lottery ticket with a certain number of lottery numbers. These lottery numbers may be selected by the customer or may be randomly selected. When random numbers are selected, the ticket distribution system 10 may include two different scenarios for picking the random numbers. In one embodiment, the ticket managing server 12 may be informed by a particular ticket printing device 14 that numbers are to be selected and will then pick random numbers (e.g., using a random number generator) and supply these numbers to the particular ticket printing device 14. In another embodiment, the ticket printing device 14 itself may be configured to randomly pick numbers if the device is equipped with a random number generator. Once the numbers are picked, the ticket printing device 14 can print the lottery ticket.

When the ticket printing device 14 selects the random numbers (or if the numbers are selected by the customer), the lottery numbers are communicated to the ticket managing server 12 in order that the ticket managing server 12 can store information about the lottery ticket sold, such as the lottery numbers on the ticket, the time and date when the ticket was sold, and the location where the ticket was sold (i.e., an establishment that houses the ticket printing device 14). If the ticket managing server 12 picks the random numbers, the ticket managing server 12 stores the same information about the lottery ticket sold (i.e., the lottery numbers, time, date, and location information). This information can be stored in the database 18.

According to some reports, the sale of lottery tickets in the United States exceeded $50 billion in 2011, which is about $200 per capita. Also, there were over 200,000 lottery ticket printing devices 14 operating in the U.S. in 2011, and the number of devices continues to rise. From this information, it can be determined that a typical ticket printing device 14 may print over 200,000 tickets per year, or more than about 20 per hour.

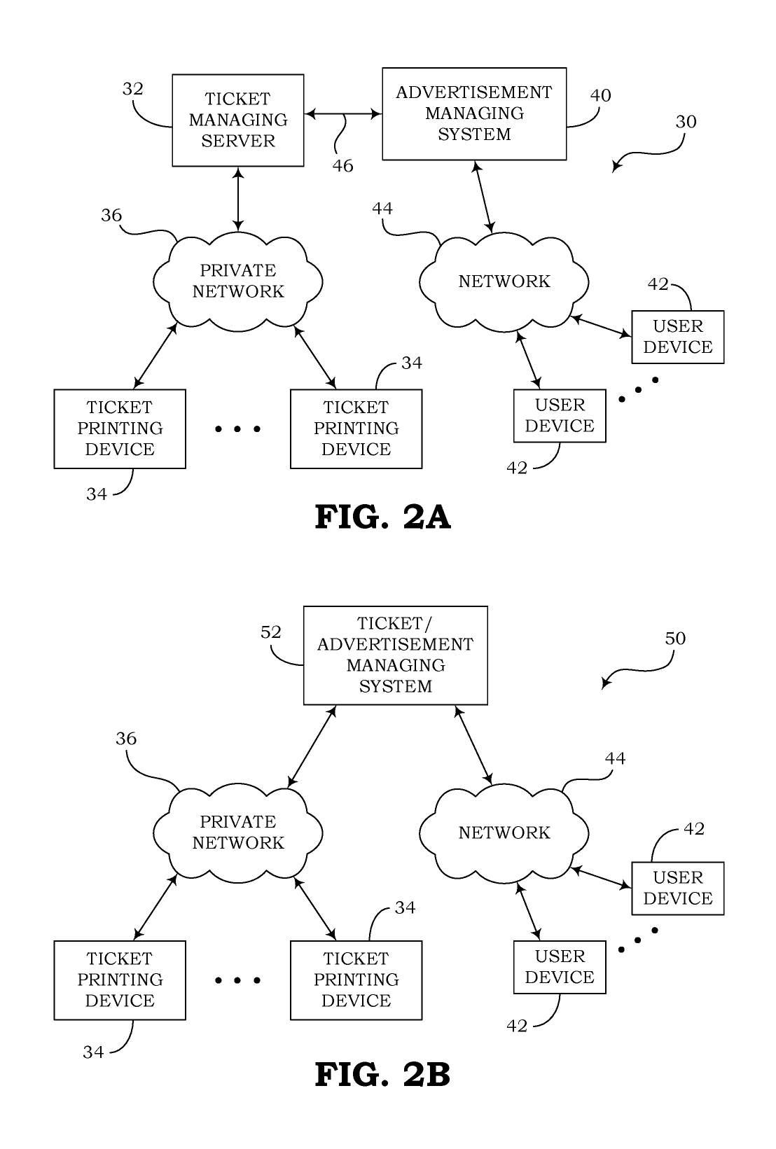

FIGS. 2A through 2D are block diagrams illustrating various embodiments of advertisement systems according to various implementations of the present disclosure. The advertisement systems of FIGS. 2A-2D include advertisement distribution systems combined with ticket distribution systems. The advertisement distribution systems can be incorporated with any type of ticket distribution system that includes printing facilities located in specific locations where an advertisement can be printed on any suitable medium. In some embodiments, the ticket distribution systems are lottery systems. The ticket printing devices 34 in these embodiments may be configured to print any type of tickets, depending on the type of system in which they are deployed. For example, in a sporting event ticket printing system, the ticket printing devices 34 may be configured to print tickets for a particular sporting event. The printed tickets may include lottery tickets, movie tickets, concert tickets, sporting event tickets, rapid transit tickets, airline tickets, or other types of tickets. In some embodiments, the ticket printing devices 34 may alternatively be configured to print other types of items (e.g., pamphlets, brochures, flyers, newspapers, magazines, etc.).

The advertisement systems of FIGS. 2A-2D may represent a system that is configured for a single state (e.g., Georgia), multiple states, a country, multiple countries, or other geographical or political regions. For example, when configured with a lottery system, one advertisement system may be located in each state, and communication may take place between systems of other states, particularly for interstate lottery games (e.g., Mega Millions, Power Ball, etc.).

It should be noted that each advertisement system of FIGS. 2A-2D may include security measures that are incorporated throughout the respective system. Thus, when an advertisement is created, security elements are added. Also, when advertisements are distributed to the ticket printing devices 34, the security elements can be verified to ensure that the advertisements are authentic. Furthermore, when an advertisement is printed, the ticket printing devices 34 may also check the security elements. The security elements may include encoding/decoding protocols, encryption/decryption protocols, or other protocols that are known by some or all of the components (e.g., the ticket managing server 32, ticket printing devices 34, and advertisement managing system 40) of the systems of FIG. 2. In some embodiments, the components of the systems may utilize code characters, passwords, or other codes that are configured to change in a certain way. For example, a code number may increase by a certain value on a regular basis (e.g., every day). Also, the components of the systems may be configured to use and check for certain advertisement characteristics to ensure security. For example, these advertisement characteristics may include a specific size of an image of the advertisement, a specific type of file, a file naming convention, a specific number of dots per inch (dpi) for the advertisements, or other characteristics.

The advertisement systems of FIGS. 2A-2D may allow an advertiser to promote local events, drive business to a particular store, promote brand affinity with local organizations (e.g., local sports teams), promote special events (e.g., sporting events, fairs, festivals, etc.), and even raise money for charity. The advertisement systems allow advertisers to easily target specific areas. Also, advertisers can run advertisements at specific times, depending on local events or other occurrences that may have a limited duration (e.g., a fair or circus in a local area, etc.).

As opposed to a system that includes an advertisement for one advertiser that is printed on all tickets in a batch, the advertisement systems of the present disclosure enable multiple advertisers to advertise as many advertisements as they wish and have the advertisements targeted at only certain locations. In this regard, the present disclosure provides a variable system that can select from among a plurality of advertisements, depending on various parameters. Also, the advertisements can be printed on a ticket, as opposed to other media, which may normally be maintained more carefully by its holder than a typical coupon. Therefore, it may be more likely that the holder will view the advertisement more often.

FIG. 2A shows an embodiment of an advertisement system 30. In this embodiment, the advertisement system 30 includes a ticket managing server 32, ticket printing devices 34, a private network 36 interconnecting the ticket managing server 32 with the ticket printing devices 34, an advertisement managing system 40, user devices 42, and a second network 44 interconnecting the advertisement managing system 40 with the user devices 42. Although not shown, the ticket printing devices 34 may, according to some implementations, be connected to the network 44. As shown, the private network 36 and second network 44 are separate from each other.

The advertisement system 30 may be incorporated into an already existing ticket distribution system that includes, for example, the ticket managing server 32, ticket printing devices 34, and private network 36. These elements may be similar to the corresponding elements shown in FIG. 1. However, according to the embodiments described in the present disclosure, the ticket distribution system portion of the advertisement system 30 not only prints tickets and records information about the tickets, but also may be configured to alter the tickets, such as by creating a space or place holder that allows one or more advertisements to also be printed on the ticket. Advertisements that are created by the advertisement managing system 40 may be stored in a database or other memory device. According to various embodiments, one or more databases or memory devices may be connected to the ticket managing server 32, the advertisement managing system 40, and/or the ticket printing devices 34. Then, when a ticket is to be printed, an advertisement is retrieved from the database and printed along with the ticket information.

Regarding the aspect of creating an advertisement or planning an advertisement strategy, the advertisement system 30 uses the advertisement managing system 40. The advertisement managing system 40 is configured to communicate with one or more user devices 42 via the network 44. According to some embodiments, the network 44 may be a local area network (LAN) and/or a wide area network (WAN), such as the Internet. The network 44 may include wired and/or wireless components. In some embodiments, the network 44 may be omitted altogether such that communication between the user devices 42 and the advertisement managing system 40 involves physically delivering a data storage device (e.g., CD, flash drive, or other portable storage device) from one device to the other.

When the network 44 is configured for local communication, the user devices 42 may represent terminals used by people who are associated with the advertisement managing system 40 for inputting advertisement orders for various clients. In other embodiments, the user devices 42 may represent computers or other processing devices connected to the advertisement managing system 40 via the Internet, where these user devices 42 are used by advertisers who wish to create an advertisement online. In this respect, the advertisement managing system 40 may include a web server for providing a website where users can create one or more advertisements and/or plan advertisement strategies or campaigns.

The ticket distribution portion and advertisement portion are combined in the embodiment of FIG. 2A by a bridge 46, which may include a permanent or removable conductor connecting the ticket managing server 32 with the advertisement managing system 40. The bridge 46 may include USB connections, a dedicated conductor, a Secure Shell (SSH) connection, or other suitable connectivity between the various servers. The servers may be synchronized using an SSH protocol. In some embodiments, the bridge 46 may be replaced with an indirect connection, such as providing information on a memory device (e.g., CD, flash drive, etc.) and physically transferring information from one device to the other. In some embodiments, the ticket managing server 32 and advertisement managing system 40 may communicate using a third network on which only these two systems communicate.

Regardless of the manner in which the devices are connected, the advertisement managing system 40 communicates advertisements and associated information to the ticket managing server 32 to enable printing of the advertisements on tickets according to specific instructions. Also, the ticket managing server 32 communicates information back to the advertisement managing system 40 providing verification that all or some of the advertisements to be printed have indeed been printed. The verification information may include advertisement information (which advertisement(s) were printed), the time and date when the advertisement(s) were printed on the tickets, when the ticket was handed to a customer, and the locations where the advertisement(s) were printed. Ticket information does not normally need to be supplied to the advertisement portion of the advertisement system 30. Therefore, the bridge 46 may provide secure communication and may prevent the user devices 42 or other components of the advertising portion of the system 30 from communicating with or hacking into the ticket managing server 32.

Communication between the ticket distribution portion of the advertisement system 30 and the advertisement portion of the advertisement system 30 may be made on a limited basis. For example, advertisements may be communicated to the ticket portion on an hourly basis, daily basis, weekly basis, or other suitable time intervals. Also, confirmation of the printing of advertisements may be communicated back to the advertisement portion on an hourly, daily, weekly, or other timely basis. It should be noted that some or all of the features described herein with respect to FIG. 2A may also be applicable to FIGS. 2B-2D as well.

FIG. 2B is a second embodiment of an advertisement system 50. The advertisement system 50 in this embodiment is similar to the system 30 of FIG. 2A, except that the ticket managing server 32 and advertisement managing system 40 are combined into one server or computer system, labeled as a ticket/advertisement managing system 52. In some embodiments, the ticket managing server 32 shown in FIG. 2A may be modified to include the features of the advertisement managing system 40 to provide the ticket/advertisement managing system 52. The modified ticket server in this respect may include a second interface device to allow communication on the second network 44. According to some embodiments, the ticket/advertisement managing system 52 may include a switch (e.g., electrical, mechanical, or electromechanical switch) that enables the system 52 to operate as a ticket managing server at some times and to operate as an advertisement managing system at other times. The switch can also be used to switch between operating over the private network 36 at some times while operating on the second network 44 at other times.

FIG. 2C shows another embodiment of an advertisement system 60. In this embodiment, the bridge 46 shown in FIG. 2A is omitted and instead the advertisement managing system 40 is configured to connect to the private network 36 via a secure connector 62. The secure connector 62 may limit the operations of the advertisement managing system 40 within the private network 36. As such, the advertisement managing system 40 may provide advertisements to the ticket managing server 32 and/or ticket printing devices 34 and receive confirmation from the ticket printing devices 34 or ticket managing server 32 as to when and where the advertisements are printed.

FIG. 2D shows another embodiment of an advertisement system 70. In this embodiment, the bridge 46 shown in FIG. 2A is omitted and instead the ticket managing server 32 is configured to connect to the network 44 via a secure connector 72. The secure connector 72 may limit or restrict the access that the components on the network 44 may have with the ticket managing server 32. The ticket managing server 32 may retrieve advertisements from the advertisement managing system 40 via the network 44 and may provide confirmation information to the advertisement managing system 40, or even directly to the user devices 42. The confirmation information may be designed to confirm which advertisements have been printed, the time and date of printing, and the locations where they were printed.

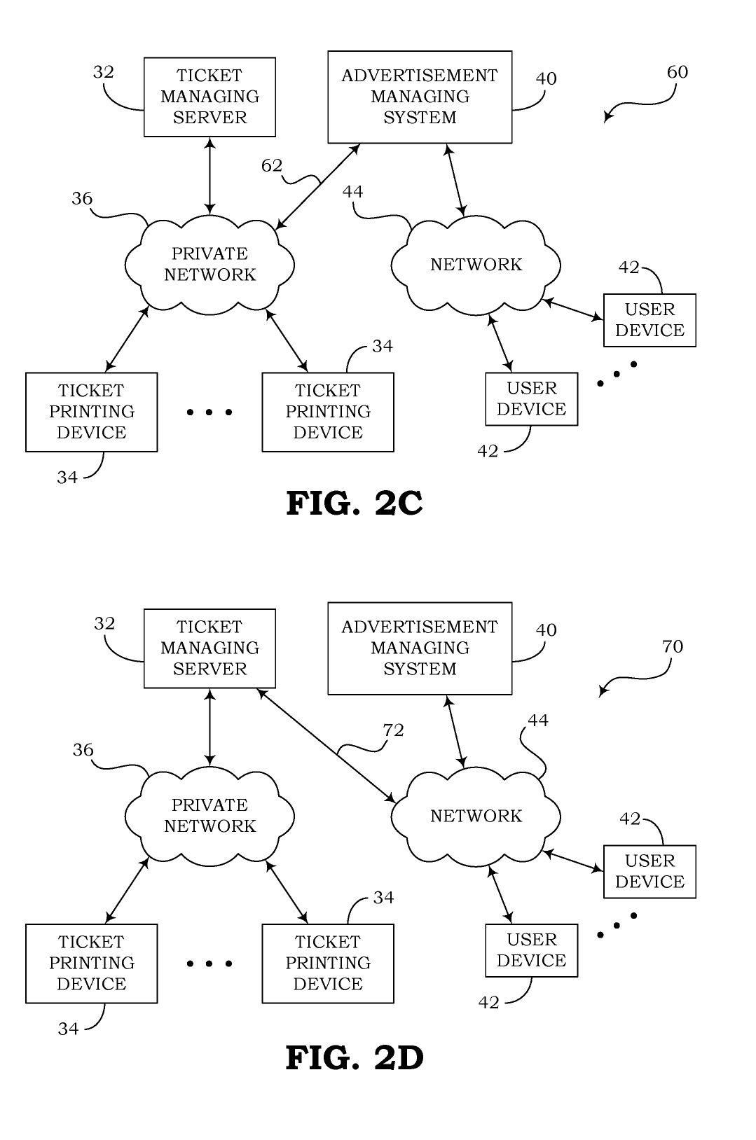

FIGS. 3A and 3B are block diagrams showing other embodiments of advertising systems according to the present disclosure. In these embodiments, in contrast to the embodiments of FIGS. 2A-2D that operate over two separate networks, the ticket distribution portions and advertisement portions exist together and operate over a common network. For example, the network in these embodiments may include a secure network. Since it may be much more expensive to operate on and maintain the private network 36, costs can be reduced by operating on a single network. Therefore, the advertisement systems of FIGS. 3A and 3B, which include both the ticket distribution portion and the advertisement portion, can operate on the Internet or other wide area network, which may be a less expensive alternative and save a large amount of money for the ticket distribution systems or state lottery systems. Additional security measures in this case may be added to prevent unauthorized access into the ticket distribution system (e.g., lottery system) via the Internet.

FIG. 3A shows an embodiment of an advertisement system 80, which includes a ticket/advertisement managing system 82, a plurality of ticket printing devices 84, and a plurality of user devices 86, interconnected by way of a network 88. The network 88 may include the Internet and may also include local or other wide area networks. In this embodiment, the ticket/advertisement managing system 82 communicates with the ticket printing devices 84 via the network 88. The ticket/advertisement managing system 82 in this embodiment may be configured to perform the ticket distribution functions and perform the advertisement functions as described in the present disclosure.

In some embodiments, the ticket/advertisement managing system 82 may be configured to communicate with the user devices 86 in a limited capacity. The user devices 86 may be used as mentioned above to create or plan an advertisement strategy. The user devices 86 may access the ticket/advertisement managing system 82 to perform the advertisement functions.

Information regarding the advertisement strategies that are created by the ticket/advertisement managing system 82 is configured to combine the advertisements, according to the advertisement strategies, with the ticket information (e.g., lottery numbers). The advertisement information and ticket information may be stored on separate databases or in the same database. The ticket/advertisement managing system 82 instructs the respective ticket printing devices 84 that when a ticket is to be printed, it is printed with the combination of a selected advertisement and ticket information on the ticket. The ticket/advertisement managing system 82 may also provide information about printed advertisements to the specific user devices 86 to inform the respective advertisers or agents associated with advertisers of the results of the advertisement strategies.

FIG. 3B is a block diagram of another advertisement system 100, which is similar to FIG. 3A. In this embodiment, however, the ticket managing server 102 and advertisement managing system 104 are individually configured as separate components on the network 88. In this way, it may be easier to separate the ticket distribution functions from the advertisement functions. Also, the ticket managing server 102 may be specifically configured to limit or restrict access by the user devices 86.

According to additional embodiments with respect to the present disclosure, the embodiments of FIGS. 2A-2D, 3A, and 3B may further include means for issuing mobile tickets, such as mobile lottery tickets or other types of mobile tickets. For example, in place of the ticket printing devices 34 and 84, a transmitter or wireless communication device may be employed using any suitable wireless protocol. The wireless communication device in this case may be configured to conduct the sale of virtual tickets to users of mobile devices (e.g., mobile phones, smart phones, tablets, laptop computers, or other mobile devices) and receive a fee for the sale of the virtual ticket.

In addition to ticket information that might normally be displayed on a display screen of the mobile device, the virtual tickets may also include an area for an advertisement. Therefore, when the ticket information is displayed, the advertisement may also be displayed on the same screen whenever the virtual ticket is shown. In some embodiments, the advertisement may be displayed on the screen independently of the display of the ticket information. For example, the advertisement may be flashed on the screen when the virtual ticket is first purchased or may be displayed at random or predetermined times after purchase.

Advertisements using the mobile device may allow the particular establishment to offer a unique advertisement to mobile device users. For example, in a restaurant environment, if a customer purchases a ticket (e.g., virtual lottery ticket), the same restaurant may utilize the advertisement systems of the present disclosure to send an ad to the customer while the customer is still on the premises. The advertisement in this case may include an instruction for the customer to “Call your waitress to find out about getting a dessert for half off” or some other type of message.

In addition to using mobile devices for receiving a virtual ticket, mobile devices may also be used in place of the user device 42, 86. Thus, the mobile device can communicate with the advertisement portion of the advertisement systems of FIGS. 2 and 3. Particularly, a user may wish to access the advertisement managing system 40, 104 via the network 44, 88 using the mobile device. In this example, the network 44, 88 may be configured to include cellular communication, Wi-Fi, or other wireless protocols. In this respect, the user may be enabled to create an advertisement and advertisement strategy using a smart phone or other mobile device.

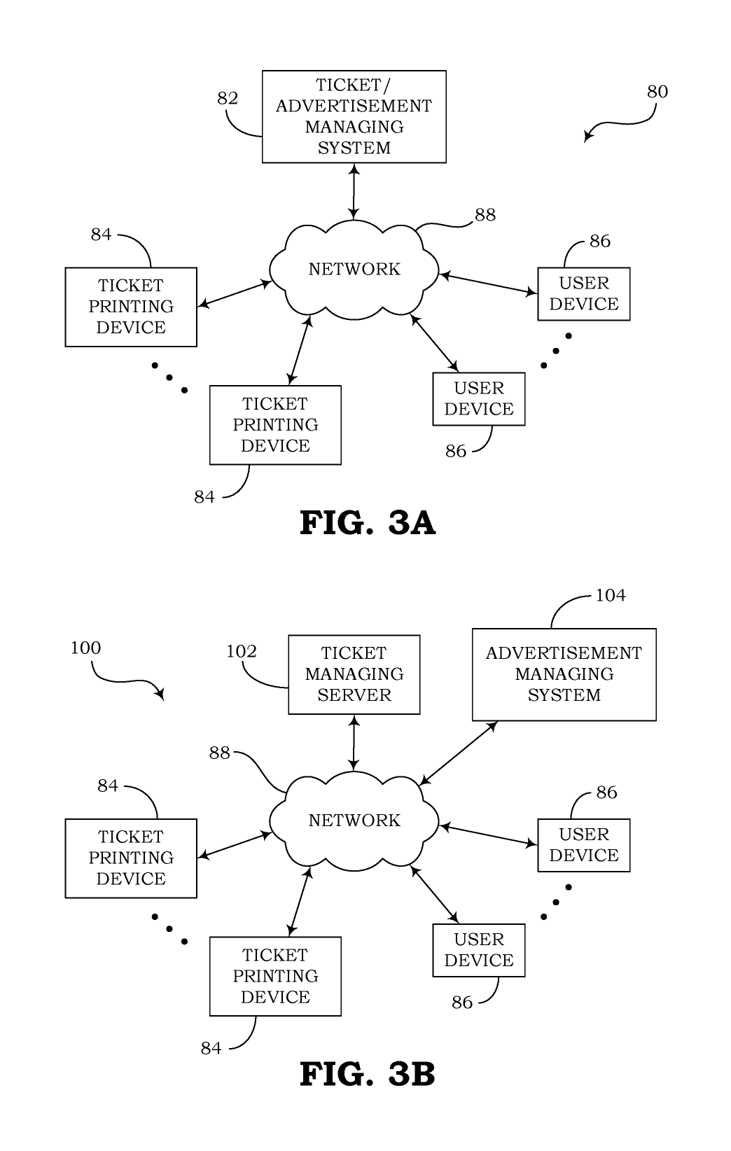

FIG. 4 is a block diagram illustrating an embodiment of an advertisement managing system 120. For example, the advertisement managing system 120 may represent any one or more of the advertisement managing systems 40, 104 and/or ticket/advertisement managing systems 52, 82 described above with respect to FIGS. 2 and 3. For the sake of clarity, when the advertisement managing system 120 represents any one or more of the ticket/advertisement managing systems 52, 82, it should be noted that the portions of the system that relate to ticket management functions have been omitted. In some embodiments, some or all of the components of the advertisement managing system 120 may be incorporated in any one or more of the ticket managing servers 32, 102 described above with respect to FIGS. 2 and 3.

As shown in FIG. 4, the advertisement managing system 120 includes an advertisement planning device 122, an advertisement verification device 124, a database 126, an advertisement distribution device 128, a print confirmation device 130, and a financial management device 132. The components of the advertisement managing system 120 may be configured in a single computer or may be configured in multiple computer systems and interconnected by a suitable network or bus interface. The computer(s) may include one or more processing devices, such as general-purpose or specific purpose processors or microcontrollers for controlling the operations and functions of the advertisement managing system 120.

The computer(s) may also include one or more memory devices, which may be configured as internally fixed storage units, removable storage units, and/or remotely accessible storage units, each including a tangible, non-transitory storage medium. The various storage units may include any combination of volatile memory (e.g., random access memory (RAM), dynamic RAM (DRAM), etc.) and non-volatile memory (e.g., read only memory (ROM), electrically erasable programmable ROM (EEPROM), flash memory, etc.). The storage units may be configured to store any combination of information, data, instructions, software code, etc.

In some embodiments, the components of the advertisement managing system 120 may be implemented in hardware, software, firmware, or any combinations thereof. For example, portions of the advertisement managing system 120 that are implemented in software or firmware may be stored on a non-transitory memory device, such as a computer-readable media device, and may be executable by a suitable instruction execution system, such as a processing device. The portions implemented in hardware may include discrete logic circuitry, an application specific integrated circuit (ASIC), a programmable gate array (PGA), a field programmable gate array (FPGA), or any combinations thereof.

The functions, operations, and/or programs executed by the advertisement managing system 120 may comprise an ordered listing of executable instructions for implementing logical functions and can be embodied in any non-transitory computer-readable medium for use by an instruction execution system or device, such as a computer-based system, processor-controlled system, etc. In the context of the present disclosure, a computer-readable medium can be any medium that can contain, store, communicate, propagate, or transport programs for execution by the instruction execution system or device. Examples of computer-readable medium may include electronic, magnetic, electromagnetic, optical, infrared, or other systems or devices.

As described in more detail below, the advertisement planning device 122 shown in FIG. 4 may be configured with the network 44, 88 and one or more user devices 42, 86 to enable a user associated with the user device 42, 86 to create an advertisement strategy. The advertisement strategy, for example, may include electronically arranged elements of an advertisement, a time period when the advertisement is to be run, and one or more predetermined locations where the advertisement is to be run. The user device 42, 86 is configured to communicate with the advertisement planning device 122 via the network 44, 88 to enable the user to create the advertisement strategy.

The advertisement managing system 120 further comprises the advertisement verification device 124, which may be in direct communication with the advertisement planning device 122. The advertisement verification device 124 is configured to automatically check for obscene or vulgar content in the advertisement. If any such content is found, the advertisement can be rejected. The automatic check may be performed by searching for profanity, certain obscene, vulgar, indecent, or morally questionable language in the text portions of the advertisement. The advertisement verification device 124 may also be configured to allow a person, such as an advertisement verifier, to visually check the content of the advertisement. This check may allow the person to prevent inappropriate content to be placed in the advertisements that might be displayed on the lottery ticket. For example, the visual check may include searching images and text for inappropriate content.

When an advertisement is created and verified, an advertisement strategy can also be created. The advertisement strategy may include, for example, the actual advertisement content (e.g., images and text), run times when the advertisement is to be revealed, and one or more locations where the advertisement is to be revealed. When completed, the advertisement strategies are stored in the database 126. The advertisement distribution device 128 accessed the database 126 in a controlled manner to retrieve advertisements from the database 126 and distribute them according to the time and location information. It may be preferable that advertisements to be revealed during a certain time period are bundled together and distributed to the ticket managing server 32 or individual ticket printing devices 34 before the actual run time so that the advertisements can be revealed at the proper times.

The print confirmation device 130 tracks the advertisements to confirm that the advertisements have been printed according to their associated time and location parameters. Also, if one or more of the ticket printing devices 34, 84 is saturated with advertisements, or, in other words, has more advertisements to print during a certain time period than actual lottery tickets that were printed during that time period, the print confirmation device 130 tracks how many of each of the advertisements were actually printed. The print confirmation device 130 may track information for the actual advertisements printed, the times and dates when they were printed, and the ticket printing devices 34, 84 that printed the advertisements (or establishment where the respective ticket printing device is located). The tracking information may be submitted to the financial management device 132 to calculate how much an advertiser might pay for the advertisements that were actually printed. The financial management device 132 may also be configured to charge an advertiser a certain fee, such as about $5.00, to submit an ad for confirmation, which will be checked by the advertisement verification device 124. The reason for charging this fee is that a person would normally be required to actually perform the visual confirmation of the ad. However, an additional fee would not be required if an ad is reused, as long as it is not edited to such an extent that another confirmation check is needed.

The advertisement planning device 122 may be further configured to introduce security elements to the advertisement strategies that are stored. These security elements can be used throughout the system to ensure that the advertisement information is communicated securely. The security elements are designed to prevent hackers from accessing the advertisements and introducing unauthorized content into the ads. The security elements also prevent other types of unfavorable intrusion into the system. The security elements may be added to the advertisement strategy information, filenames assigned to the advertisement strategies, or other files associated with the advertisement strategies.

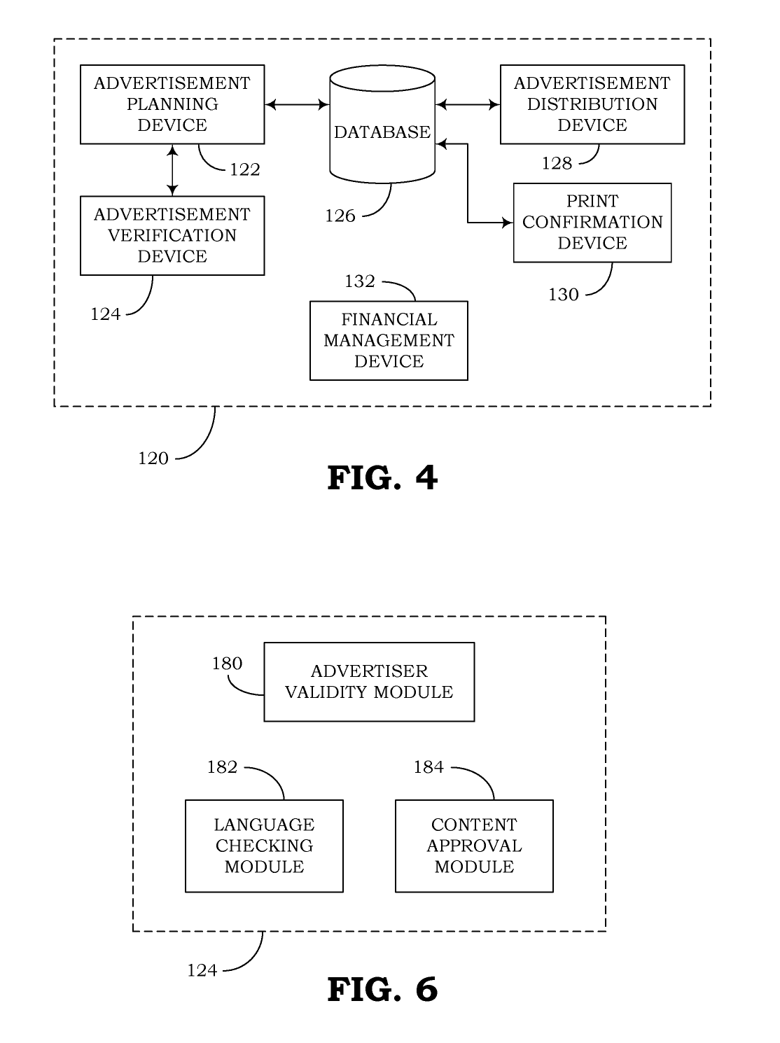

FIG. 5 is a block diagram showing an embodiment of the advertisement planning device 122 shown in FIG. 4. As mentioned above, the advertisement planning device 122 is configured to enable a user (e.g., an advertiser) to create an advertisement strategy. In some embodiments, the advertisement planning device 122 may be a web-based portal that allows the user to create the advertisement strategy online using a remote computer. The advertisement planning device 122 allows multiple users to create a plurality of advertisement strategies that can be distributed and run on multiple ticket printing devices.

According to various embodiments, the advertisement planning device 122 includes an interface module 138, an account module 140, a run time module 142, a location selection module 144, a ticket type selection module 145, a quantity module 146, a payment calculation module 147, a security/identification module 148, a database manager 149, and an advertisement creating module 150. The advertisement creating module 150 may include, according to the illustrated embodiment, a processing device 152, a memory module 154, a template storage module 158, an upload module 160, a display module 162, an advertiser information module 164, an image managing module 166, and a text managing module 168.

The interface module 138 is configured to enable a user device 42 associated with a user (e.g., an advertiser) to communicate with the advertisement planning device 122 via a network 44, 88. In this way, the user may utilize the advertisement planning device 122 to create an advertisement and plan an advertisement strategy.

The account module 140 allows a user to create an account for an advertiser. The user logs in to an established account whenever the user wishes to create and/or edit one or more advertisement strategies, which may also be referred to as an advertisement campaign. As mentioned above, the advertisement strategy includes not only an advertisement, but also a time period when the advertisement is to be run and one or more locations where the advertisement is to be run. The advertisement strategy may also include a quantity value that represents a maximum number of advertisements to be revealed. The act of revealing the advertisement, as mentioned above, may include the printing of the advertisement on, for example, a lottery ticket. The account module 140 may also be configured to receive advertiser information, such as a physical billing address, information regarding a contact person or manager, e-mail information, billing information, contact information, and other information.

The run time module 142 enables a user to enter run time information. For example, the run time module 142 may allow the user to enter a time period as short as one hour (e.g., from 5:00 to 6:00 pm on a particular Friday), to run indefinitely, or any other suitable time period. The run times may be entered as a start time and an end time. In some embodiments, the run times may include entry of specific times every week (e.g., from 1:00 to 6:00 pm every Thursday and Friday). Therefore, the user may select specific days and/or hours when the ads are run.

The location selection module 144 allows a user to select one or more specific locations where the advertisements are to be printed. Using the location selection module 144, the user can select a nationwide target (e.g., every ticket printing device 34, 84 in the United States), a statewide target (e.g., every ticket printing device 34, 84 in the state of Georgia), a citywide scope, countywide scope, zip code scope, or any other definable scope or target. Also, the location selection module 144 may allow the user to select the ticket printing devices 34, 84 within a certain distance from a certain point. For example, the user may wish to select locations for printing the advertisements at the locations of the ticket printing devices that are within a certain distance from the advertiser's store(s). As an example, a local pizza restaurant may wish to target printing locations that are within 5 miles of its building. In another example, a business may own several stores or a chain of stores and may wish to target the printing locations within a certain distance from each of those stores. In some embodiments, the location selection module 144 may provide an interactive map that the user can access to select specific printing locations. Printing locations may be selected in groups, individually, a combination of groups and individually, or any other manner. Selecting locations may also involve performing a search for locations in a certain area and selecting one or more printing locations from the search results.

The ticket type selection module 145 is configured to allow the user to select which type or types of tickets the advertisements are to run on. For example, in a movie ticket system, the user can pick one or more movies (e.g., The Avengers, Thor, Iron Man 3, etc.). The advertisements will be scheduled to be printed on the tickets for those selected movie(s). Also, in the example of the lottery system, the user can select the type of lottery game (e.g., Pick 3, Pick 4, etc.), and the advertisement will be scheduled to be printed on the tickets for those selected game(s). The ticket type selection module 145 also allows the user to select other types of details, depending on the type of ticket, specifics of those tickets, and other factors.

The advertisement planning device 122 also has a quantity module 146, which allows the user to enter a maximum number of times that the advertiser wishes to have the advertisement printed. The quantity module 146 may be in communication with a payment calculation module 147, which is configured to determine the cost of having the advertisement printed the selected number of times. The advertising cost may be variable, depending on a number of factors. For example, certain times of the day may be more desirable and may incur a higher cost, whereas other times may incur a smaller cost. The cost may be based on the quantity of ads requested in the quantity module 146. For instance, if a higher number of ads are requested, the cost per ad may be reduced, whereas printing fewer ads may cost more per ad. Also, different types of businesses may have different advertisement cost scales. As an example, the advertising cost may be on the order of about five cents, ten cents, 25 cents, one dollar, five dollars, or other amount for each advertisement printed. The payment calculation module 147 may include a bidding system that prioritizes the printing of ads based on a highest bidder.

The advertisement creating module 150 includes a processing device 152 that is configured to control its overall functions for creating an advertisement. The advertisement creating module 150 is configured to enable a user to create, upload, modify, and/or select one or more images, logos, etc. into an advertisement to be created. The user can also enter text. The advertisement creating module 150 allows the user to electronically organize elements of an advertisement by manipulating the image and text elements of the advertisement within a designated space in an advertisement window and custom design the way the advertisement may be displayed. The display module 162 may be configured to create the advertisement window for showing the user how the advertisement might appear, where the window may represent the size and shape of the advertisement area on a ticket. The advertisement creating module 150 is configured to enable the user to spatially arrange the elements of the advertisement within an area having a predetermined size and shape.

The user may add images from different sources. A first source is the template storage module 158, which may contain multiple generic images that may be selected. The template storage module 158 may allow the user to select different categories (e.g., restaurants, etc.) and further select sub-categories (e.g., pizza restaurants, etc.) and so on. Regarding the example of a pizza restaurant, the template storage module 158 may store various images of pizzas or slices of pizzas that may be used by the user for creating an advertisement for their pizza restaurant. The template storage module 158 may also include templates of advertisement text or coupons that may be related to the categories, sub-categories, etc. For example, pizza restaurant ad templates may include an advertisement for “$2 off a large pizza,” “Buy one pizza, get a second one free,” etc. These templates can be modified by the image managing module 166 and/or text managing module 168 to some extent.

The advertisement creating module 150 also contains an upload module 160 that allows the user to upload images, logos, trademarks, etc. for the advertiser. With the standard images from the template storage module 158 and the images uploaded with the upload module 160 available in the processing device 152, the user is able to arrange the size and location of the images in the advertisement. The display module 162 may be used to display the advertisement or to process the visual images to show how the ad may look and convey these images to be displayed on the user device 42, 86. At this point, the display module 162 may show what the ad will look like if it were saved and printed, but may simply include code that defines the size and location characteristics. The display module 162 may allow the elements in the ad being created to be moved around the screen. In some embodiments, the display module 162 may include a basket that allows items to be selected and used when needed. The items can be dragged out of the basket and placed wherever the user wishes.

The advertiser information module 164 of the advertisement creating module 150 is configured to enable the user to enter specific advertiser information that may be printed on the advertisement. The advertiser information module 164 may allow entry of the name of the business or advertiser, one or more physical addresses of the businesses, phone numbers for the businesses, or other information. The information about the advertiser may be printed as part of the advertisement so that a ticket purchaser can find and/or contact the business. This information may be more applicable for use with small businesses. For larger businesses, text such as “Valid at participating stores” or other similar message may be selected.

Other additional text may be entered using the text managing module 168. For example, the text managing module 168 may enable the user to include customized coupon information, quotes, direction information to clarify the location of an establishment, or other text. The text managing module 168 also enables the user to enter other information that can be printed on the advertisement. For example, the user may enter text that defines a special deal or coupon offer, such as “$2.00 off a large pizza”. The user may also enter a textual phrase, such as “Big Bob's Pizza is the Best!”

The memory module 154 is configured to store an advertisement that the user creates using the advertisement creating module 150. The advertisements at this stage may contain images, text, and code that defines the physical arrangement of the images and text within the ad window. When the user has completed the advertisement and wishes to have it verified, the stored advertisement is transmitted from the memory module 154 to the advertisement verification device 124 via the interface module 138. When the advertisement is verified and considered acceptable for printing, the processing device 152 may be configured to combine the various image and text elements and store the ad in a pdf, jpeg, gif, or other file format in the memory module 154. Also, the saved ad can be stored in the database 126 by way of the database manager 149.

When an advertisement strategy is created, the security/identification module 148 is configured to add security elements to the advertisement strategy. An arrangement can be determined beforehand that security will include certain coding/decoding elements, certain encryption/decryption elements, etc. In this way, only the compatible components in the system (i.e., the ticket managing server, advertisement managing system, and ticket printing devices) will recognize and understand what security elements are in place and will be able to process the advertisement strategies without issue. At the same time, the security elements will prevent unauthorized tampering or hacking of the advertisement strategies by external devices.

The security elements added by the security/identification module 148 may include ensuring that the advertisement features include a certain size or dimensions, that the advertisement includes a specific dpi resolution, that the advertisement strategy includes a specific file naming convention, that a password is added that is only recognized by the compatible devices, or other security features. Also, other components of the advertisement systems will understand the security features. A component of the system that receives an advertisement strategy at a later stage can check the MAC address, IP address, computer identification code, computer key, or other identification number of the sending component (e.g., advertisement planning device 122) to determine if is being received from a reliable source. Algorithms can be used to change passwords or number codes on a regular basis in a manner that is known by the other devices. These and other security measures can be taken by the security/identification module 148 to protect the integrity of the advertisement systems.

According to various implementations, the one or more predetermined locations entered by the user correspond to one or more establishments where the advertisement is to be revealed. The location selection module 144 is configured to enable the user to select the one or more predetermined locations on at least one of a nationwide scale, statewide scale, citywide scale, countywide scale, and zip-code scale. The location selection module 144 is also configured to enable the user to select the one or more predetermined locations based on a distance of the one or more predetermined locations from one or more stores associated with an advertiser.

Using the advertisement planning device 122, an advertiser may wish to create an advertisement strategy having a specific ad image, time and location information etc. Then, the advertiser may also wish to create another advertisement strategy with the same ad image, but with different times and/or locations. With multiple advertisement strategies, the advertiser can customize how the ads are to be distributed. For example, an advertiser may want to advertise more heavily in an area closer to the location of the business. Also, the advertiser may wish to advertise with different ads in different regions to appeal to the interest (e.g., local sports teams) in the respective regions.

Once an advertisement strategy is created by the advertisement creating module 150, the advertisement strategy can be stored in a database (e.g., database 126) using the database manager 149. The database manager 149 may be configured to include additional information to be stored with the advertisement strategy and enter the information in the database in an organized manner.

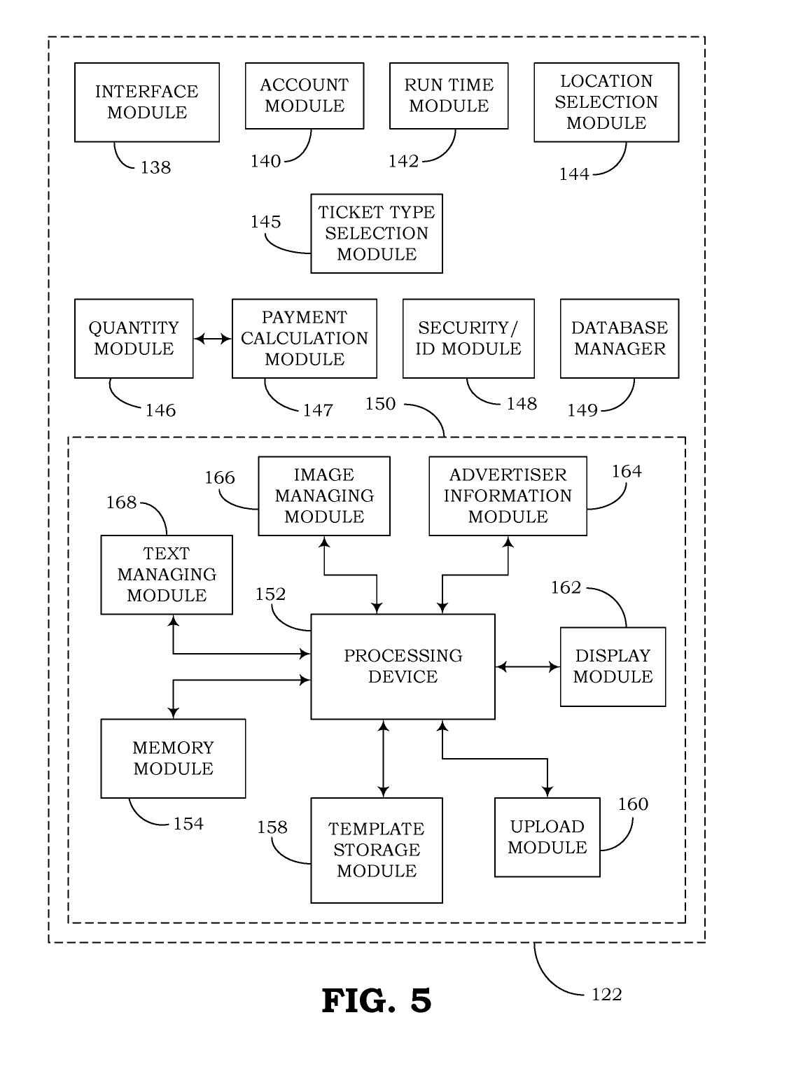

FIG. 6 is a block diagram of an embodiment of the advertisement verification device 124 shown in FIG. 4. The advertisement verification device 124 in this embodiment includes an advertiser validity module 180, a language checking module 182, and a content approval module 184. The advertiser validity module 180 is configured to determine whether the advertiser is a legitimate business. This may be determined by checking with business records for a particular state (e.g., Georgia), such as the Secretary of State records. Also, the advertiser validity module 180 can determine if an address of the business is near the specific addresses where the ads are to be run. If not, then the advertiser validity module 180 may determine that an error has occurred. The advertiser validity module 180 can also run a credit check, check a license to operate, check phone numbers and addresses of the business, or other perform other checks to determine if the entered information for the advertiser is or appears to be valid.

The language checking module 182 is configured to analyze the text that is entered in an advertisement and check it with predetermined words or phrases that may be considered to be offensive, vulgar, obscene, or inappropriate in any way, depending on censorship criteria for a state or state lottery system. For example, a state or state lottery system may determine that certain content, such as those related alcohol, sex, etc., are not permitted in the advertisements and will not be approved for printing. If inappropriate words or phrases are present in the ad, the advertisement verification device 124 informs the user that the advertisement has been rejected. The reasons for rejection may also be provided to the user.

If an advertisement is approved by the language checking module 182, the advertisement can then be checked by a human reviewer. The advertisement may be forwarded to the content approval module 184. In some embodiments, the content approval module 184 may be configured to present the advertisement to the reviewer, who can review the advertisement and check for content (i.e., images, text, etc.) to determine if the advertisement is appropriate according to the specific censorship criteria set by the state or lottery system. The criteria may be different for different states or lottery systems and may require the reviewer to understand the particular censorship guidelines thereof. If the reviewer deems that the advertisement is appropriate for general audiences, the advertisement verification device 124 approves the advertisement for printing and may notify the user that the advertisement can be used. If it is not appropriate, the user is notified that the advertisement has been rejected. In some embodiments, the reviewer may call the advertiser to clear up any issues.

It should be understood that the routines, steps, processes, or operations described herein may represent any module or code sequence that can be implemented in software or firmware. In this regard, these modules and code sequences can include commands or instructions for executing the specific logical routines, steps, processes, or operations within physical components. It should further be understood that two or more of the routines, steps, processes, and/or operations described herein may be executed substantially simultaneously or in a different order than explicitly described, as would be understood by one of ordinary skill in the art.

The implementations described herein represent a number of possible implementations and examples and are not intended to necessarily limit the present disclosure to any specific implementations. Instead, various modifications can be made to these implementations as would be understood by one of ordinary skill in the art. Any such modifications are intended to be included within the spirit and scope of the present disclosure and protected by the following claims.

1. An advertisement planning program encoded on a non-transitory computer-readable medium and executable by a processing device, the advertisement planning program comprising:
an advertisement creating module configured to enable a remote user to create an advertisement to be displayed within an advertisement area on each of one or more media components;
a run time module configured to enable the remote user to enter one or more time periods during which the advertisement is to be initially displayed within the advertisement area on the one or more media components; and
a location selection module configured to enable the remote user to select one or more remote locations where the advertisement is to be initially displayed;
wherein the advertisement creating module is configured to enable the remote user to electronically insert at least one of a graphical element and a textual element into a window representing a predetermined size and shape of the advertisement area, the advertisement creating module being further configured to enable the remote user to spatially arrange the at least one of the graphical element and textual element within the window.

2. The advertisement planning program of claim 1, further comprising a quantity module configured to enable the remote user to enter a maximum number of times that the advertisement is to be initially displayed during the entered one or more time periods.

3. The advertisement planning program of claim 1, further comprising an interface module configured to communicate with a user device via a network, wherein the user device enables the remote user to provide information to the advertisement planning program.

4. The advertisement planning program of claim 1, further comprising:
an account module configured to enable the remote user to establish an account for an advertiser associated with the remote user; and
an advertiser information module configured to enable the remote user to enter information about the advertiser.

5. The advertisement planning program of claim 1, wherein the location selection module is configured to enable the remote user to select the one or more remote locations based on at least one of a nationwide scale, statewide scale, citywide scale, countywide scale, and zip-code scale, wherein the one or more remote locations correspond to one or more establishments where the advertisement is to be initially displayed, wherein the location selection module is configured to enable the remote user to select the one or more remote locations based on a distance from one or more establishments associated with an advertiser, and wherein the location selection module is configured to enable the remote user to select the one or more remote locations using an interactive map.

6. The advertisement planning program of claim 1, further comprising a database manager configured to store an advertisement strategy in a database, the advertisement strategy including the advertisement, information regarding the entered one or more time periods, and information regarding the selected one or more remote locations.

7. The advertisement planning program of claim 6, further comprising a security/identification module configured to encode or encrypt data in the advertisement strategy to enable at least one operation of the operations of preventing unauthorized access to the advertisement strategy and allowing a remote validation device to validate the advertisement as authentic, wherein the advertisement creating module, run time module, and location selection module are configured to create a plurality of advertisement strategies for a plurality of advertisers, and wherein advertisements associated with the advertisement strategies are to be initially displayed at a plurality of remote locations during a plurality of time periods.

8. The advertisement planning program of claim 1, wherein the advertisement creating module is configured to enable the remote user to select an image template from a template storage module.

9. The advertisement planning program of claim 1, wherein the advertisement creating module is further configured to transmit the advertisement to an advertisement verification system to check for inappropriate content in the advertisement.

10. The advertisement planning program of claim 1, wherein the run time module is configured to enable the remote user to select specific hours of one or more days when the advertisement is to be displayed.

11. The advertisement planning program of claim 1, wherein the one or more media components are one or more tickets, each ticket entitling a bearer of the respective ticket to enter a place, travel by public transport, participate in an event, or enter a lottery or raffle.

12. The advertisement planning program of claim 11, wherein the advertisement is distributed to one or more ticket printing devices at the one or more remote locations to be printed on the one or more tickets during the entered one or more time periods.

13. The advertisement planning program of claim 11, wherein the one or more tickets are lottery tickets, wherein the advertisement is printed in the advertisement area of each of the lottery tickets, and wherein lottery numbers are printed in another area on each of the lottery tickets.

14. The advertisement planning program of claim 11, wherein the one or more tickets are virtual tickets stored on one or more mobile devices in the one or more remote locations, wherein the advertisement is distributed to the one or more mobile devices for initial display with the virtual ticket.

15. An advertising system comprising:
an advertisement planning device configured to receive input from an advertiser to create an advertisement strategy, the advertisement strategy including an advertisement to be displayed on one or more media components, a time period when the advertisement is to be initially displayed, and one or more remote locations where the advertisement is to be initially displayed;
a wide area network; and
a user device associated with the advertiser, the user device configured to communicate with the advertisement planning device via the wide area network to enable the advertiser to create the advertisement strategy;
wherein the advertisement planning device is configured to enable the advertiser to create the advertisement by electronically inserting at least one of a graphical element and a textual element into a window representing a predetermined size and shape of an advertisement area of the one or more media components; and
wherein the advertisement planning device is further configured to enable the advertiser to electronically arrange the at least one of the graphical element and textual element within the window.

16. The advertising system of claim 15, further comprising an advertisement verification system in communication with the advertisement planning device, the advertisement verification system configured to automatically check for inappropriate content in the advertisement, wherein the advertisement verification system is further configured to visually display the advertisement to a verifier and receive verification information from the verifier regarding the appropriateness of the advertisement.

17. The advertising system of claim 15, wherein the user device is a mobile device.

18. The advertising system of claim 15, wherein the advertisement planning device is further configured to add one or more security elements to the advertisement strategy to enable at least one operation of the operations of preventing unauthorized access to the advertisement strategy via the wide area network and allowing a remote validation device to validate the advertisement as authentic.

19. The advertising system of claim 15, wherein the advertisement planning device is further configured to enable the advertiser to create a plurality of advertisement strategies, wherein each advertisement strategy includes at least one of selected location parameters, quantity parameters, and cost per ad parameters.

20. The advertising system of claim 15, wherein the one or more media components are one or more tickets, each ticket entitling a bearer of the respective ticket to enter a place, travel by public transport, participate in an event, or enter a lottery or raffle.

21. The advertising system of claim 20, wherein the advertisement planning device is further configured to enable the user to select a type of ticket on which the advertisement is to be displayed.

22. The advertising system of claim 20, wherein the one or more tickets are virtual tickets displayed on one or more mobile devices in the one or more remote locations, and wherein the advertisement is initially displayed in an advertisement area of each of the virtual tickets.

23. The advertising system of claim 15, wherein the one or more media components include one or more video display devices.
